(19) United States
(12) Patent Application Publication
(10) Pub. No.: US 2022/0276662 A1
(43) Pub. Date: Sep. 1, 2022

(54) Real-time Vehicle State Estimation and Sensor Management

(71) Applicant: LOON LLC, Mountain View, CA (US)

(72) Inventors: Sameera Sylvia Ponda, Mountain View, CA (US); Salvatore J. Candido, Mountain View, CA (US)

(73) Assignee: LOON LLC, Mountain View, CA (US)

(21) Appl. No.: 17/187,195

(22) Filed: Feb. 26, 2021

(51) Int. Cl. G05D 1/10; G05D 1/04; G07C 5/08; G07C 5/00; B64C 39/02

(52) U.S. Cl. CPC G05D 1/104; G05D 1/042; G07C 5/0808; G07C 5/008; B64C 39/024; B64C 2201/146; B64C 2201/126; B64C 2201/042

(57) ABSTRACT

The technology relates to real-time state estimation and sensor management. A method for real-time state estimation and sensor management may include receiving telemetry from a fleet of aerial vehicles, storing telemetry in a telemetry buffer, generating a real-time state estimate of an aerial vehicle in the fleet using a group of estimators, the estimators being of one or more types, such as a sensor management estimator, a bias and noise management estimator, and a physical modeling estimator, and providing the real-time state estimate of the aerial vehicle to a job in a fleet management system.

### BACKGROUND OF INVENTION

Aerial vehicles are being deployed for many different types of missions and purposes, including providing data connectivity (e.g., broadband and other wireless services), weather observations, Earth observations, cargo transport, and more. Different missions entail different objectives, including different expected vehicle lifetimes, altitude ranges, climates traveled. Effective and efficient control of said aerial vehicles is desirable, and such control requires reliable, consistent and actionable state data and other telemetry for the aerial vehicle. In some circumstances, however, such data may become unreliable, inaccurate, incomplete, or unavailable for periods of time, due to power or communications outages, or other software or hardware errors or faults. Typically, such circumstances pose risks to persons, structures and other vehicles in proximity, as well as to the aerial vehicle itself. A system of estimators that can accurately and reliably estimate such state data and other telemetry for the aerial vehicle would minimize such risks.

Thus, it is beneficial to have improved techniques for real-time state estimation and sensor management.

### BRIEF SUMMARY

The present disclosure provides techniques for real-time state estimation and sensor management. A method for state estimation for an aerial vehicle may include receiving telemetry from a fleet of aerial vehicles; storing the telemetry in a telemetry buffer; generating a real-time state estimate of an aerial vehicle in the fleet using a plurality of estimators, the plurality of estimators comprising one or a combination of a sensor management estimator, a bias and noise management estimator, and a physical modeling estimator; and providing the real-time state estimate of the aerial vehicle to a job in a fleet management system. In some examples, the method may include causing the fleet management system to: generate a command based on the real-time state estimate; and send the command to the aerial vehicle.

In some examples, the command is configured to cause the aerial vehicle to change its altitude. In some examples, the command is configured to cause the aerial vehicle to turn off power to a component. In some examples, the command is configured to cause the aerial vehicle to change a mode of operation. In some examples, the command is configured to cause the aerial vehicle to drop an increment of ballast. In some examples, the job is implemented by a flight simulator configured to predict future states of the aerial vehicle. In some examples, the job is implemented by a controller configured to generate a command for a next action for the aerial vehicle. In some examples, the job is implemented by a dispatcher configured to assign the aerial vehicle to a mission. In some examples, the job is implemented by a vehicle allocator configured to allocate the aerial vehicle to a dispatcher. In some examples, the job is implemented in a datacenter as a standalone job, wherein the job is configured to be queried by a remote procedure call from another job.

In some examples, generating the real-time state estimate comprises generating a lifetime estimate by a zero pressure estimator, the lifetime estimate comprising an estimated number of days until a probability that the aerial vehicle will reach a zero pressure threshold exceeds a zero pressure probability threshold. In some examples, generating the real-time state estimate further comprises: generating a temperature estimate by a temperature estimator configured to model the temperature estimate based on one or a combination of, a solar estimate, an ambient temperature estimate, an infrared estimate, and a pressure estimate, generating a gas amount estimate by a gas estimator, and generating a leak rate estimate by a physics estimator, wherein the lifetime estimate is based on the leak rate. In some examples, generating the real-time state estimate comprises generating a solar power estimate by a solar power estimator, the solar power estimate comprising an estimated distribution of power available for a given period of time. In some examples, the given period of time is until a next sunrise. In some examples, generating the real-time state estimate further comprises: generating a battery state estimate by a battery state estimator, generating a solar capture estimate by a solar estimator configured to estimate an amount of solar power being captured by one or more solar panels onboard the aerial vehicle, and generating a position estimate by a position estimator, wherein the solar power estimate is based on the battery state estimate, the solar capture estimate, and a time of day based in part on the position estimate. In some examples, generating the real-time state estimate comprises generating a ballast drop estimate by a ballast drop estimator. In some examples, the telemetry buffer is configured to store asynchronously received telemetry and provide a most recent version of the telemetry to the plurality of estimators. In some examples, generating the real-time state estimate comprises selecting a sensor signal from a plurality of sensor signals, wherein one or more of the plurality of sensor signals is filtered. In some examples, generating the real-time state estimate comprises fusing a plurality of sensor signals.

A distributed computing system comprising: a distributed database configured to store flight simulation data and geographical restrictions data; and one or more processors configured to: receive telemetry from a fleet of aerial vehicles; store the telemetry in a telemetry buffer; generate a real-time state estimate of an aerial vehicle in the fleet using a plurality of estimators, the plurality of estimators comprising one or a combination of a sensor management estimator, a bias and noise management estimator, and a physical modeling estimator; and provide the real-time state estimate of the aerial vehicle to a job in a fleet management system.

### BRIEF DESCRIPTION OF THE DRAWINGS

FIGS. 1A-1B are diagrams of exemplary operational systems by which real-time state estimation and sensor management may be implemented, in accordance with one or more embodiments;

FIG. 2 is a diagram of an exemplary network, in accordance with one or more embodiments;

FIG. 3A is a simplified block diagram of an exemplary computing system forming part of the systems of FIGS. 1A-2, in accordance with one or more embodiments;

FIG. 3B is a simplified block diagram of an exemplary distributed computing system for implementing real-time state estimation and sensor management, in accordance with one or more embodiments;

FIG. 4 is a simplified block diagram of an exemplary real-time state estimation and sensor management system, in accordance with one or more embodiments;

FIGS. 5A-5C are estimator flow diagrams illustrating exemplary dependency trees comprising estimators in a real-time state estimation and sensor management system, in accordance with one or more embodiments;

FIG. 6 is a flow diagram illustrating an exemplary method for real-time state estimation and sensor management, in accordance with one or more embodiments; and

FIG. 7 is a flow diagram illustrating an exemplary method for using real-time state estimation and sensor management to control an aerial vehicle, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for managing nighttime power for solar-powered vehicles. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driving vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to real-time state estimation and sensor management. A status or state of an aerial vehicle may be estimated by a real-time state estimation system to facilitate effective and efficient control of the aerial vehicle. A plurality of estimators may be implemented to provide estimated telemetry and/or state of an aerial vehicle where the aerial vehicle's own sensors and subsystems are unable to provide updated telemetry and/or state information. The plurality of estimators may comprise estimator modules communicatively connected to each other, directly or indirectly, in a dependency tree to ensure the estimators are run in an appropriate order as specified by the dependency tree. Estimators may be run on a distributed computing system, as described herein, with input from one or more aerial vehicles in a fleet as well as various other data sources. Data sources may include weather stations (e.g., airborne weather balloons, fixed or mobile ground weather stations), other nodes in a network (e.g., aerial vehicles carrying sensors and communications units), and networked sources of data (e.g., weather model data from the National Oceanic and Atmospheric Administration's (NOAA's) Global Forecast System (GFS), European Center for Medium-Range Weather Forecast's (ECMWF's) high resolution forecasts (HRES), and the like, manually entered data from a flight engineer or operator, and other data).

Estimators may comprise sensor management estimators, bias and noise management estimators, and physical modeling estimators, among others. Sensor management estimators may be configured to track all sensors of a given class (e.g., all position sensors, all pressure sensors, temperature sensors) and compute a sensor estimate based on a fused signal (i.e., a filtered blend of all sensors of the given class), a filtered signal (i.e., corresponding to one of the available sensors), or a preferred filtered signal (i.e., a filtered signal corresponding to a most accurate available sensor according to a hierarchy of accuracy). In some examples, an operator may select one of these signal modes by which to operate the sensor management estimators. In other examples, a real-time state estimation and sensor management system may automatically select one of these signal modes, either based on one or more predetermined factors (e.g., time of day, type of estimator, types of sensors, number of sensors available, etc.) or dynamically (e.g., based on sensor performance, simulations, machine learning models, etc.). An output of a sensor management estimator comprises a reliable sensor estimate usable by dependent estimators.

In circumstances where off-the-shelf (OTS) sensors are being used, an operational environment for said OTS sensors (i.e., an environment wherein the OTS sensor is expected to perform accurately and as expected) may be characterized and compared against actual sensor environments (e.g., high altitude, stratospheric) to predict noise and bias due to sensor environments outside of the range of the operational environment for a given sensor. Bias and noise management estimators may be configured to monitor actual sensor environments to determine when they are outside the range of the operational environment of the sensor and to filter raw sensor data to estimate biases and remove noise (e.g., using a Kalman filter, extended Kalman filter, or other filtering algorithm). In some examples, bias and noise management estimators may depend on outputs from, or be used in conjunction with, sensor management estimators. For example, an ambient temperature estimator may perform sensor management estimation with several ambient temperature sensors, and also may use output from a solar flux estimator to determine if any one of the ambient temperature sensors is likely to be corrupted by solar radiation (i.e., solar insolation). In this example, an ambient temperature estimate may be based on filtered sensor data during the night, when one or more ambient temperature sensors are expected to perform accurately and the sensor environment matches the operational environment. In this example, the ambient temperature estimate may switch during the day to using a weather model forecast or nowcast (e.g., NOAA GFS, ECMWF HRES, an ensemble, and the like), a bias-corrected version of an ambient temperature sensor measurement, or a fused combination of both, when temperatures are expected to exceed a range in the operational environment.

For telemetry that is not directly measured through physical sensors, physical modeling estimators (i.e., software only sensors) use physical and mathematical models to predict (e.g., in an open-loop model) expected states or generate measurements (e.g., an amount of gas in a vehicle, a gas leak rate, a solar elevation, an azimuth and flux, an amount of solar power being captured by onboard solar panels, solar flux exposure, and the like) without hardware. In some examples, such physical model estimates are based on actual telemetry or outputs from other estimators (e.g., position estimate and time to determine a solar elevation, azimuth and flux at an aerial vehicle's current location, for example, using a solar model and an atmospheric attenuation model). An example of a physical modeling estimator may include a physics estimator configured to estimate one, or a combination, of an amount of gas and/or air in a lighter-than-air vehicle, a gas leak rate, a hole size (i.e., of a ballonet), an air mass flow rate, and the like. Another example of a physical modeling estimator may include a thermal model configured to estimate a gas temperature.

A final layer of estimators may be configured to generate a real-time state estimate for an aerial vehicle for use by other jobs in a fleet management system. A fleet management system may comprise one or more subsystems including, without limitation, a vehicle allocator (e.g., to allocate vehicles to a dispatcher based on objectives and/or missions), a dispatcher, a controller, a flight policy, a trajectory planner, a map builder (e.g., weather map, storm map, flight map), an alerts monitor (i.e., configured to monitor telemetry and/or other flight information and send alerts to a vehicle), an ephemeral logic layer (i.e., to implement overriding controllers for overriding conditions, e.g., avoiding storms, restricted flight zones, zero pressure conditions), a simulator (e.g., to run flight simulations for predicting a future state of the aerial vehicle and/or for any of the other subsystems), and other navigation jobs. In some examples, the simulator may be configured to run Monte Carlo simulations. In some examples, the alerts monitor, the ephemeral logic layer, and other checklists layers can detect a failure from an estimator output, and send messages and/or alerts either automatically to the vehicle for an automated response (e.g., power on or off a component, change a power or operation mode, and the like) or to a user interface monitored by a flight engineer or operator (i.e., user) for a manual response (e.g. if a sensor is broken a user can switch to another sensor, or if a set of critical sensors is malfunctioning they can send the flight to recovery, or if some other physical damage is detected (e.g. a suddenly increasing leak rate, an ACS system failure), they can take the flight out of service and send to recovery, and the like).

### Example Systems

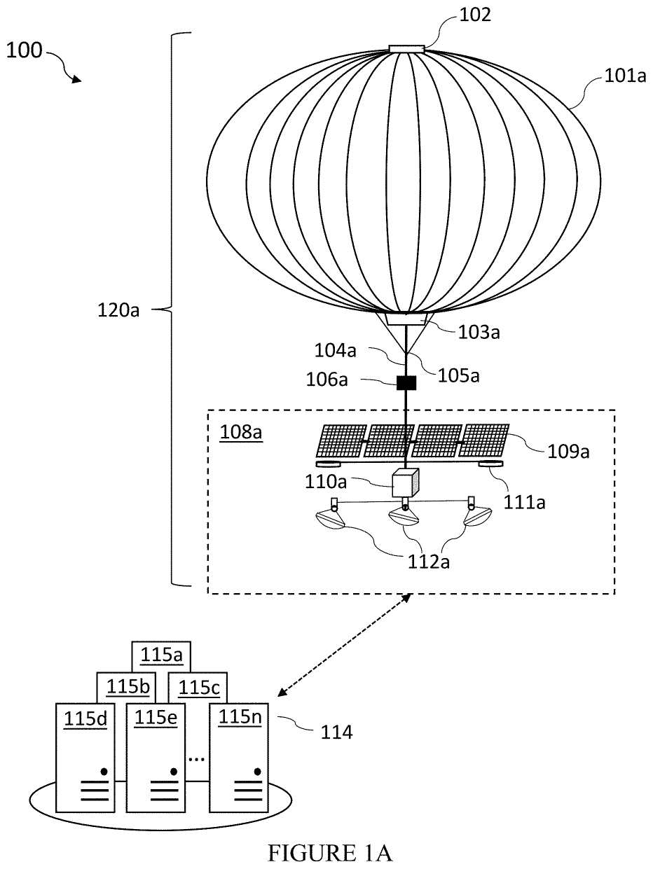

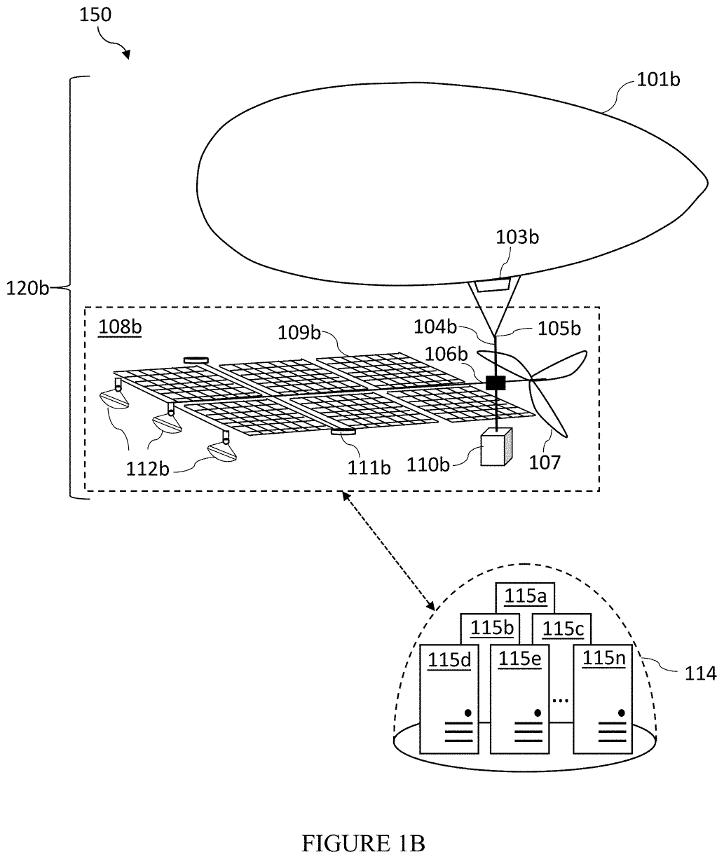

FIGS. 1A-1B are diagrams of exemplary operational systems by which real-time state estimation and sensor management may be implemented, in accordance with one or more embodiments. In FIG. 1A, there is shown a diagram of system 100 for control and operation of aerial vehicle 120a. In some examples, aerial vehicle 120a may be a passive vehicle, such as a balloon or satellite, wherein most of its directional movement is a result of environmental forces, such as wind and gravity. In other examples, aerial vehicles 120a may be actively propelled. In an embodiment, system 100 may include aerial vehicle 120a and ground station 114. In this embodiment, aerial vehicle 120a may include balloon 101a, plate 102, altitude control system (ACS) 103a, connection 104a, joint 105a, actuation module 106a, and payload 108a. In some examples, plate 102 may provide structural and electrical connections and infrastructure. Plate 102 may be positioned at the apex of balloon 101a and may serve to couple together various parts of balloon 101a. In other examples, plate 102 also may include a flight termination unit, such as one or more blades and an actuator to selectively cut a portion and/or a layer of balloon 101a. In other examples, plate 102 further may include other electronic components (e.g., a sensor, a part of a sensor, power source, communications unit). ACS 103a may include structural and electrical connections and infrastructure, including components (e.g., fans, valves, actuators, etc.) used to, for example, add and remove air from balloon 101a (i.e., in some examples, balloon 101a may include an interior ballonet within its outer, more rigid shell that may be inflated and deflated), causing balloon 101a to ascend or descend, for example, to catch stratospheric winds to move in a desired direction. Balloon 101a may comprise a balloon envelope comprised of lightweight and/or flexible latex or rubber materials (e.g., polyethylene, polyethylene terephthalate, chloroprene), tendons (e.g., attached at one end to plate 102 and at another end to ACS 103a) to provide strength and stability to the balloon structure, and a ballonet, along with other structural components. In various embodiments, balloon 101a may be non-rigid, semi-rigid, or rigid.

Connection 104a may structurally, electrically, and communicatively, connect balloon 101a and/or ACS 103a to various components comprising payload 108a. In some examples, connection 104a may provide two-way communication and electrical connections, and even two-way power connections. Connection 104a may include a joint 105a, configured to allow the portion above joint 105a to pivot about one or more axes (e.g., allowing either balloon 101a or payload 108a to tilt and turn). Actuation module 106a may provide a means to actively turn payload 108a for various purposes, such as improved aerodynamics, facing or tilting solar panel(s) 109a advantageously, directing payload 108a and propulsion units (e.g., propellers 107 in FIG. 1B) for propelled flight, or directing components of payload 108a advantageously.

Payload 108a may include solar panel(s) 109a, avionics chassis 110a, broadband communications unit(s) 111a, and terminal(s) 112a. Solar panel(s) 109a may be configured to capture solar energy to be provided to a battery or other energy storage unit, for example, housed within avionics chassis 110a. Avionics chassis 110a also may house a flight computer (e.g., computing device 301, as described herein), a transponder, along with other control and communications infrastructure (e.g., a controller comprising another computing device and/or logic circuit configured to control aerial vehicle 120a). Communications unit(s) 111a may include hardware to provide wireless network access (e.g., LTE, fixed wireless broadband via 5G, Internet of Things (IoT) network, free space optical network or other broadband networks). Terminal(s) 112a may comprise one or more parabolic reflectors (e.g., dishes) coupled to an antenna and a gimbal or pivot mechanism (e.g., including an actuator comprising a motor). Terminal(s) 112(a) may be configured to receive or transmit radio waves to beam data long distances (e.g., using the millimeter wave spectrum or higher frequency radio signals). In some examples, terminal(s) 112a may have very high bandwidth capabilities. Terminal(s) 112a also may be configured to have a large range of pivot motion for precise pointing performance. Terminal(s) 112a also may be made of lightweight materials.

In other examples, payload 108a may include fewer or more components, including propellers 107 as shown in FIG. 1B, which may be configured to propel aerial vehicles 120a-b in a given direction. In still other examples, payload 108a may include still other components well known in the art to be beneficial to flight capabilities of an aerial vehicle. For example, payload 108a also may include energy capturing units apart from solar panel(s) 109a (e.g., rotors or other blades (not shown) configured to be spun, or otherwise actuated, by wind to generate energy). In another example, payload 108a may further include or be coupled to an imaging device, such as a downward-facing camera and/or a star tracker. In yet another example, payload 108a also may include various sensors (not shown), for example, housed within avionics chassis 110a or otherwise coupled to connection 104a or balloon 101a. Such sensors may include Global Positioning System (GPS) sensors, wind speed and direction sensors such as wind vanes and anemometers, temperature sensors such as thermometers and resistance temperature detectors (i.e., RTDs), speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

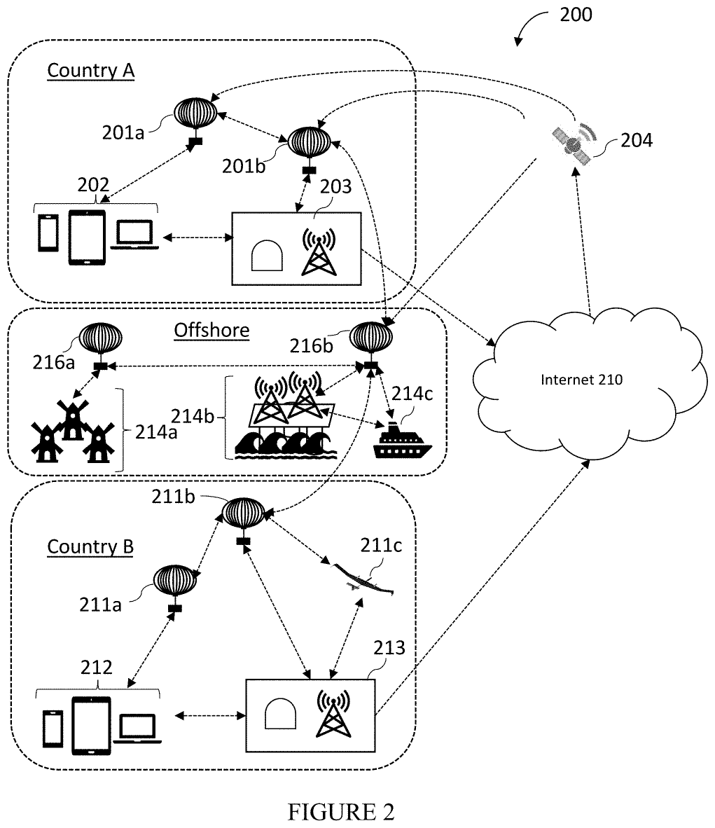

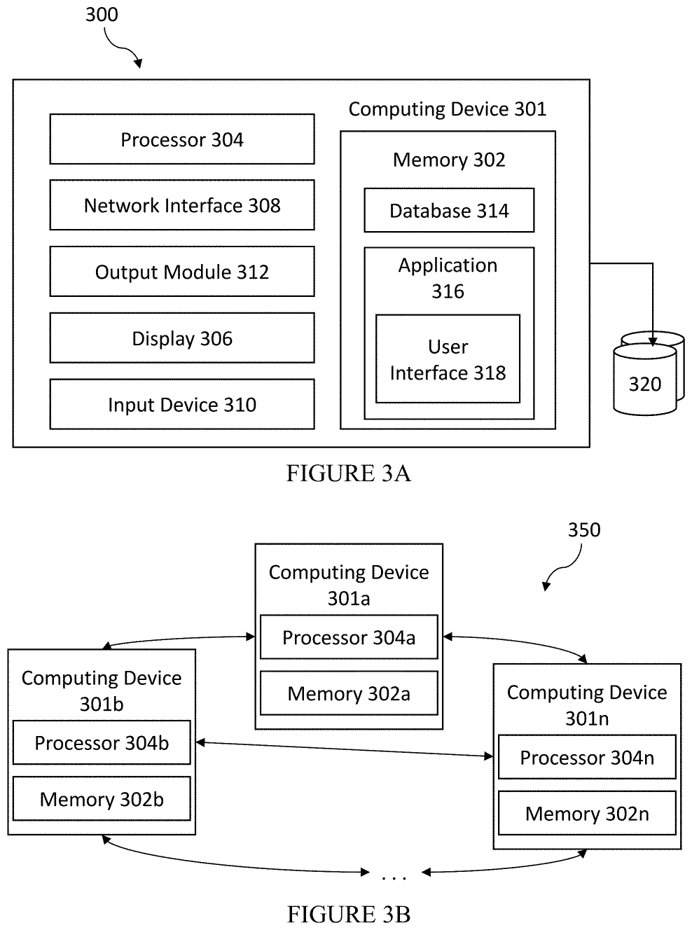

Ground station 114 may include one or more server computing devices 115a-n, which in turn may comprise one or more computing devices (e.g., computing device 301 in FIG. 3). In some examples, ground station 114 also may include one or more storage systems, either housed within server computing devices 115a-n, or separately (see, e.g., computing device 301 and repositories 320). Ground station 114 may be a datacenter servicing various nodes of one or more networks (e.g., aerial vehicle network 200 in FIG. 2).

FIG. 1B shows a diagram of system 150 for control and operation of aerial vehicle 120b. All like-numbered elements in FIG. 1B are the same or similar to their corresponding elements in FIG. 1A, as described above (e.g., balloon 101a and balloon 101b may serve the same function, and may operate the same as, or similar to, each other). In some examples, balloon 101b may comprise an airship hull or dirigible balloon. In this embodiment, aerial vehicle 120b further includes, as part of payload 108b, propellers 107, which may be configured to actively propel aerial vehicle 120b in a desired direction, either with or against a wind force to speed up, slow down, or re-direct, aerial vehicle 120b. In this embodiment, balloon 101b also may be shaped differently from balloon 101a, to provide different aerodynamic properties. In some examples, balloon 101b may include one or more fins (not shown) coupled to one or more of a rear, upper, lower, or side, surface (i.e., relative to a direction in which balloon 101b is heading).

As shown in FIGS. 1A-1B, aerial vehicles 120a-b may be largely wind-influenced aerial vehicles, for example, balloons carrying a payload (with or without propulsion capabilities) as shown, or fixed wing high altitude drones (e.g., aerial vehicle 211c in FIG. 2) with gliding and/or full propulsion capabilities. However, those skilled in the art will recognize that the systems and methods disclosed herein may similarly apply and be usable by various other types of aerial vehicles.

FIG. 2 is a diagram of an exemplary aerial vehicle network, in accordance with one or more embodiments. Aerial vehicle network 200 may include aerial vehicles 201a-b, user devices 202, and ground infrastructure 203, in Country A. Aerial vehicle network 200 also may include aerial vehicles 211a-c, user devices 212, and ground infrastructure 213 in Country B. Aerial vehicle network 200 also may include offshore facilities 214a-c and aerial vehicles 216a-b servicing at least said offshore facilities 214a-c. Aerial network 200 may further include satellite 204 and Internet 210. Aerial vehicles 201a-b, 211a-c, and 216a-b may comprise a balloon, other floating (i.e., lighter than air), propelled or partially propelled (i.e., propelled for a limited amount of time or under certain circumstances, and not propelled at other times or under other circumstances), fixed-wing, or other types of high altitude aerial vehicles, as described herein. For example, aerial vehicles 201a-b, 211a-c, and 216a-b may be the same or similar to aerial vehicles 120a-b described above. User devices 202 and 212 may include a cellular phone, tablet computer, smart phone, desktop computer, laptop computer, and/or any other computing device known to those skilled in the art. Ground infrastructure 203 and 213 may include an always-on or fixed location computing device (i.e., capable of receiving fixed broadband transmissions), a ground terminal (e.g., ground station 114), a tower (e.g., a cellular tower), and/or any other fixed or portable ground infrastructure for receiving and transmitting various modes of connectivity described herein known to those skilled in the art. User devices 202 and 212, ground infrastructure 203 and 213, and offshore facilities 214a-c, may be capable of receiving and transmitting signals to and from aerial vehicles 201a-b, 211a-c, and 216a-b, and in some cases, to and from each other. Offshore facilities 214a-c may include industrial facilities (e.g., wind farms, oil rigs and wells), commercial transport (e.g., container ships, other cargo ships, tankers, other merchant ships, ferries, cruise ships, other passenger ships), and other offshore applications.

Aerial vehicle network 200 may support ground-to-vehicle communication and connectivity, as shown between ground infrastructure 203 and aerial vehicle 201b, as well as aerial vehicles 211b-c and ground infrastructure 213. In these examples, aerial vehicles 201b and 211b-c each may exchange data with either or both a ground station (e.g., ground station 114), a tower, or other ground structures configured to connect with a grid, Internet, broadband, and the like. Aerial vehicle network 200 also may support vehicle-to-vehicle (e.g., between aerial vehicles 201a and 201b, between aerial vehicles 211a-c, between aerial vehicles 216a-b, between aerial vehicles 201b and 216b, between aerial vehicles 211b and 216b), satellite-to-vehicle (e.g., between satellite 204 and aerial vehicles 201a-b, between satellite 204 and aerial vehicle 216b), vehicle-to-user device (e.g., between aerial vehicle 201a and user devices 202, between aerial vehicle 211a and user devices 212), and vehicle-to-offshore facility (e.g., between one or both of aerial vehicles 216a-b and one or more of offshore facilities 214a-c) communication and connectivity. In some examples, ground stations within ground infrastructures 203 and 213 may provide core network functions, such as connecting to the Internet and core cellular data network (e.g., connecting to LTE EPC or other communications platforms, and a software defined network system) and performing mission control functions. In some examples, the ground-to-vehicle, vehicle-to-vehicle, and satellite-to-vehicle communication and connectivity enables distribution of connectivity with minimal ground infrastructure. For example, aerial vehicles 201a-b, 211a-c, and 216a-b may serve as base stations (e.g., LTE eNodeB base stations), capable of both connecting to the core network (e.g., Internet and core cellular data network), as well as delivering connectivity to each other, to user devices 202 and 212, and to offshore facilities 214a-c. As such, aerial vehicles 201a-b and 211a-c represent a distribution layer of aerial vehicle network 200. User devices 202 and 212 each may access cellular data and Internet connections directly from aerial vehicles 201a-b and 211a-c.

FIG. 3A is a simplified block diagram of an exemplary computing system forming part of the systems of FIGS. 1A-2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301 (not shown). In some examples, storage system 320 may store state data, commands (e.g., flight, navigation, communications, mission, fallback), flight simulation data, geographical restrictions data, and other various types of information as described herein. This information may be retrieved or otherwise accessed by one or more computing devices, such as computing device 301 or server computing devices 115a-n in FIGS. 1A-1B, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 350 in FIG. 2B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks (e.g., encoding flight policies, as described herein) and data regarding wind patterns, weather forecasts, past and present locations of aerial vehicles (e.g., aerial vehicles 120a-b), sensor data, simulation data, geographical characteristics and restrictions data, map information, air traffic information, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In some examples computing device 301 may be located remote from an aerial vehicle (e.g., aerial vehicles 120a-b) and may communicate with and/or control the operations of an aerial vehicle, or its control infrastructure as may be housed in avionics chassis 110a-b, via a network. In one embodiment, computing device 301 is a data center or other control facility (e.g., configured to run a distributed computing system as described herein), and may communicate with a controller and/or flight computer housed in avionics chassis 110a-b via a network. As described herein, system 300, and particularly computing device 301, may be used for planning a flight path or course for an aerial vehicle based on wind and weather forecasts to move said aerial vehicle along a desired heading or within a desired radius of a target location. Various configurations of system 300 are envisioned, and various steps and/or functions of the processes described below may be shared among the various devices of system 300, or may be assigned to specific devices.

FIG. 3B is a simplified block diagram of an exemplary distributed computing system for implementing aerial vehicle launch and land site selection, in accordance with one or more embodiments. System 350 may comprise two or more computing devices 301a-n. In some examples, each of 301a-n may comprise one or more of processors 304a-n, respectively, and one or more of memory 302a-n, respectively. Processors 304a-n may function similarly to processor 304 in FIG. 3, as described above. Memory 302a-n may function similarly to memory 302 in FIG. 3, as described above.

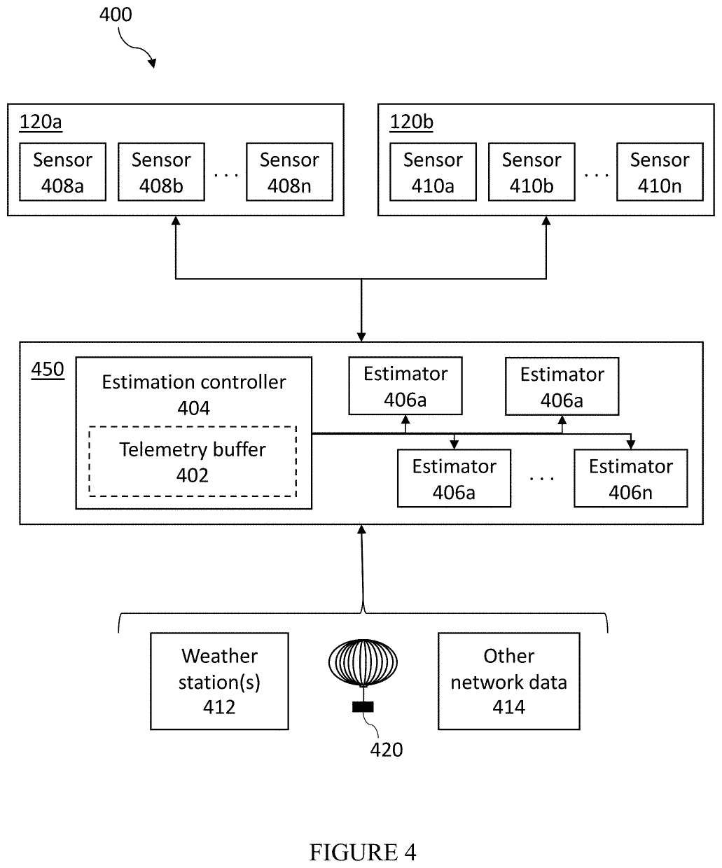

FIG. 4 is a simplified block diagram of an exemplary real-time state estimation and sensor management system, in accordance with one or more embodiments. System 400 may include aerial vehicle 120a carrying sensors 408a-n, vehicle 120b carrying sensors 410a-n, computing system 450, and various data sources, such as weather station(s) 412, other vehicle 420, and other network data 414. Computing system 450 may include estimation controller 404 and a plurality of estimators 406a-n. In some examples, computing system 450 may be implemented using a distributed computing system (e.g., system 350 in FIG. 3B) implemented in a ground station or other infrastructure comprising a distributed computing system (e.g., ground station 114 in FIGS. 1A-1B, ground infrastructure 203 and 213 in FIG. 2). In other examples, estimation controller 404 and the plurality of estimators 406a-n may be implemented in an individual or centralized computing system (e.g., computing system 300 in FIG. 3A).

In some examples, estimation controller 404 may be configured to facilitate configuration of the plurality of estimators 406a-n based on one or more factors, including predetermined rules, user input, availability of telemetry data, content of telemetry data, reliability of telemetry data, and the like. Sensors 408a-n and 410a-n may be configured to transmit telemetry to estimation controller 404, which may implement, optionally, a telemetry buffer 402. Primary telemetry signals from sensors 408a-n and 410a-n (e.g., from position, pressure, and other key sensors) may be received by telemetry buffer in every telemetry message received from aerial vehicles 120a-b. Secondary telemetry signals from sensors 408a-n and 410a-n (e.g., voltage reading from a hardware component, heater-related value, weather model data) may be sent asynchronously (i.e., a secondary telemetry signal may be sent by a sensor periodically according to a cadence that is longer than the cadence for primary telemetry signals or may be sent by a sensor consistently only at certain times of the day or may be triggered by other events, such as a change in a subsystem or mode of operation). In some examples, telemetry buffer 402 may be configured to store each telemetry value, and may store a time that each telemetry value was last updated. Telemetry buffer 402 may be configured to store the most recent update for each telemetry value, or it may store a plurality of each telemetry value (i.e., a given number of values or for a given time period of updates). Telemetry buffer 402 may be configured to provide to each of the plurality of estimators 406a-n the telemetry values useful to said estimator.

In an example, telemetry buffer 402 may receive and store a position value and pressure value update with every telemetry message (e.g., every 1-15 seconds using some networks, 45-60 seconds using other networks, or more or less, depending on speed and cost of a network), a temperature sensor value and weather model data in longer intervals (i.e., periodically and not in every telemetry message, such as with every second or third message, or other interval), and a battery voltage reading at inconsistent intervals (e.g., before sunset, periodically during nighttime only, at each operational or power mode change). At a given time, telemetry buffer 402 may have stored a position value and a pressure value received in the last 15 seconds, a temperature sensor value received 60 seconds ago, weather model data received over 5 minutes ago, and a battery voltage reading received just after the last sunrise. Telemetry buffer 402 may be configured to handle variation in periods between each telemetry message as well, for example, wherein there is a switch from a faster network to a slower network. The plurality of estimators 406a-n may be configured to retrieve or receive such sensor values from telemetry buffer 402, rather than directly from telemetry messages from aerial vehicles 120a-b, as telemetry buffer 402 does the work of storing and tracking the latest sensor values.

The plurality of estimators 406a-n may include, without limitation, satellite communications success estimators (i.e., different satcom estimators for different satellite networks), ACS-related estimators (e.g., ACS set point, ACS power), a superpressure estimator (i.e., configured to select from one or more pressure sensors, e.g., a ballonet pressure sensor, an apex pressure sensor, and fused sensor data, to determine probability or other risk value associated with a burst threshold), a volume estimator, a weather model estimator (i.e., configured to select and extract key weather data from a weather model forecast (e.g., NOAA GFS, ECMWF HRES, an ensemble, and the like)), a communication subsystems estimator (e.g., configured to estimate a health state of a communication subsystem (e.g., LTE unit, communications terminal), a storm estimator (i.e., configured to estimate a proximity and/or likelihood of a storm), zero pressure estimator (i.e., configured to estimate a probability of reaching a zero pressure threshold, for example, in a given number of days), ballast-related estimators (e.g., a ballast estimator, a ballast drop estimator) (i.e., configured to estimate an amount of ballast remaining onboard, an amount or increment of ballast to drop and/or a time to drop ballast), a mass estimator, gas-related estimators (e.g., remaining gas, gas leak rate), thermal-related estimators (e.g., ambient temperature estimator, infrared (IR) estimator, gas temperature estimator), solar-related estimator (e.g., solar estimator, sunrise/sunset estimator, solar power estimator) (i.e., configured to estimate an amount or rate of solar power being captured, a time until next sunrise or sunset, a distribution of solar power available for a given period of time, such as until the next sunrise), a velocity estimator, power-related estimators (e.g., a critical battery estimator, a solar power estimator, a load estimator) (i.e., configured to estimate a future time and/or probability that the battery power will fall below a critical battery threshold, whether to change power modes (e.g., to conserve battery power or to restore more operational functions after a period of power conservation), estimate a distribution of solar power usage for a given period of time, estimate an electrical load for operating in various modes (e.g., a low power mode, a current mode, a full operational mode) for a period of time (e.g., through a night, until a next sunrise, a given number of hours)), and a position estimator (i.e., configured to select from a primary GPS (e.g., a primary flight controller GPS), a fused GPS signal, a satcom bridge GPS, other flight controller GPS, star tracker, other position sensors).

The plurality of estimators 406a-n may comprise sensor management estimators, bias and noise management estimators, and physical modeling estimators, among others. Sensor management estimators may be configured to track all sensors of a given class (e.g., all position sensors, all pressure sensors, temperature sensors) and compute a sensor estimate based on a fused signal (i.e., a filtered blend of all sensors of the given class), a filtered signal (i.e., corresponding to one of the available sensors), or a preferred filtered signal (i.e., a filtered signal corresponding to a most accurate available sensor according a hierarchy of accuracy). Bias and noise management estimators may be configured to monitor actual sensor environments to determine when they are outside the range of the operational environment of the sensor and to filter raw sensor data to estimate biases and remove noise (e.g., using a Kalman filter, extended Kalman filter, or other filtering algorithm). Physical modeling estimators use physical and mathematical models to predict (e.g., in an open-loop model) expected states (e.g., an amount of gas in a vehicle (i.e., by a gas estimator), a gas leak rate (i.e., by a physics estimator), a solar elevation (i.e., by a sunrise estimator), an azimuth and flux, an amount of solar power being captured by onboard solar panels (i.e., by a solar estimator), solar flux exposure, and the like).

In an example, there may be multiple pressure sensors, including at least a higher precision pressure sensor and a lower precision pressure sensor. A pressure estimator may be configured to generate a pressure estimate based on a filtered blend of the higher precision pressure sensor and the lower precision pressure sensor or based on a preference for a filtered signal corresponding to the higher precision pressure sensor, selecting a filtered signal from the lower precision pressure sensor when the higher precision pressure sensor is unavailable (e.g., due to a failure in the higher precision pressure sensor, in a connection to the communications unit, a selective power failure or outage) or inaccurate (e.g., the higher precision pressure sensor may be more sensitive to shifts in temperature, its accuracy may be in a narrower range of pressures). In another example, there may be two or more position sensors on board an aerial vehicle (i.e., for redundancy, of varying precision, able to operate accurately in different conditions, using different signal sources for positioning). A position estimator may be configured to generate a position estimate based on a filtered blend of global positioning tracking sensors (e.g., a cell-based GPS, a satellite communications GPS, a star tracker, position tracking using other vehicles in a mesh network), based on a filtered signal from a predetermined primary GPS, or based on a preferred filtered signal wherein one of the global positioning tracking sensors is selected as a primary GPS at given times depending on one or more predetermined factors or dynamically (e.g., in consideration of sensor performance, simulations, machine learning models, etc.).

In addition to receiving telemetry from aerial vehicles 120a-b, in order to generate a real-time state estimate for one or both of aerial vehicles 120a-b, computing system 450 may retrieve, or otherwise receive, data from other sources, including weather station(s) 412, other vehicle 420, and other network data 414. Weather station(s) 412 may comprise a fixed ground weather station, an airborne weather balloon, or other mobile weather station. Other vehicle 420 may include any kind of vehicle described herein (e.g., vehicles 201a-b, 211a-c, and 216a-b, in FIG. 2, other nodes in a network of vehicles (e.g., a fleet forming a mesh network), and any other kind of high altitude or medium altitude aircraft). Other network data 414 may include weather model forecasts and nowcasts, manually entered data (e.g., by a flight engineer or operator), automatically generated alerts from one or more jobs or subsystems in a fleet management system, and other data.

Each of the plurality of estimators 406a-n may depend on outputs from another of the plurality of estimators 406a-n, and thus the plurality of estimators 406a-n may be implemented according to a dependency tree, such that each of the plurality of estimators 406a-n may run based on outputs from others of the plurality of estimators 406a-n from which said estimator depends. In some examples, the plurality of estimators 406a-n may be run in an order according to their position in a dependency tree. In other examples, the plurality of estimators 406a-n may be run in parallel using the last output from the one or more estimators from which a given estimator depends.

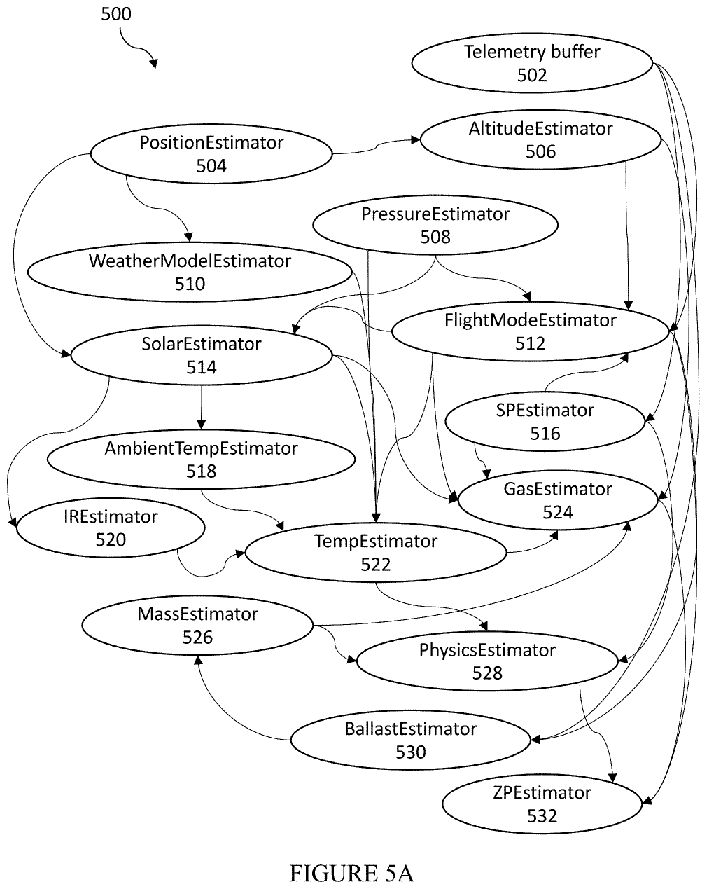

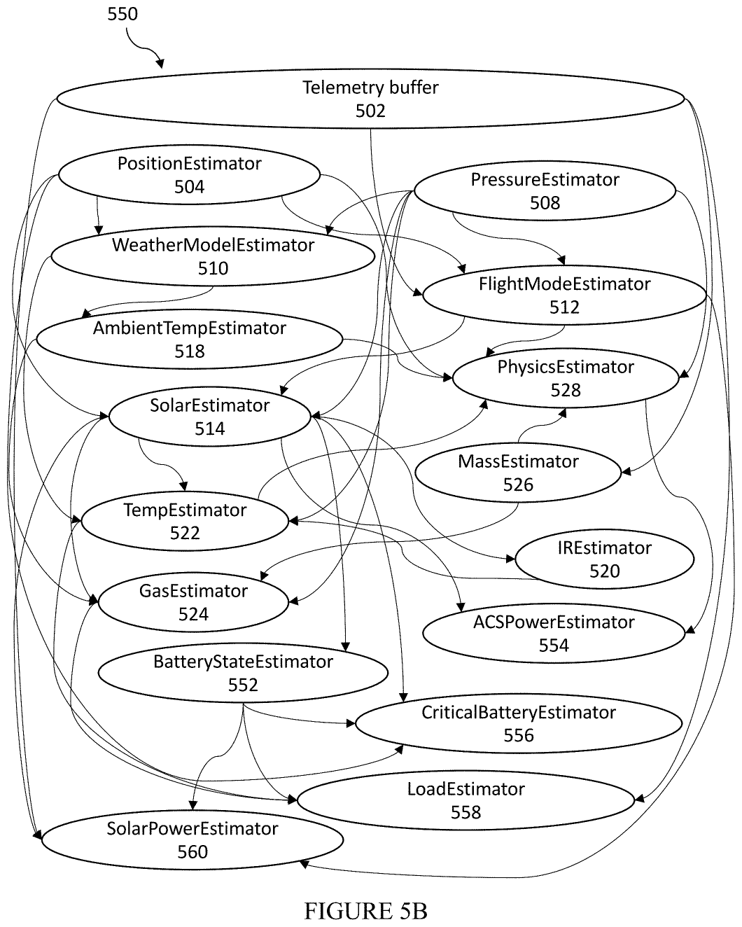

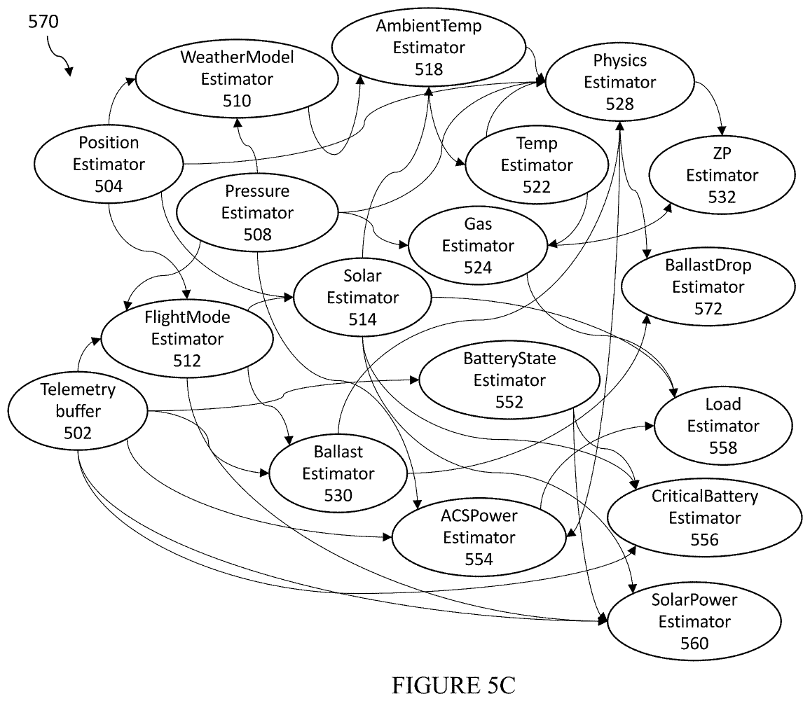

FIGS. 5A-5C are estimator flow diagrams illustrating exemplary dependency trees comprising estimators in a real-time state estimation and sensor management system, in accordance with one or more embodiments. For example, FIG. 5A shows an exemplary dependency tree for health and lifetime estimation. Dependency tree 500 shows a first tier of estimators, including telemetry buffer 502, position estimator 504, altitude estimator 506, and pressure estimator 508, generating estimates on which downstream estimators depend in order to generate their respective estimates. The first tier of estimators may derive or compute their estimates from sensor data, telemetry buffer 502, and/or other data sources. In an example, weather model estimator 510 may depend on a position estimate (e.g., latitude, longitude, altitude, relative position) from position estimator 504 in order to provide a weather data estimate for a vehicle's current position. In another example, flight mode estimator 512 may depend on a pressure estimate (i.e., gas pressure) from pressure estimator 508, altitude estimate (i.e., altitude of vehicle) from altitude estimator 506, a superpressure estimate (i.e., a probability or other risk value of reaching a burst threshold in a given time period) from superpressure estimator 516, and telemetry from telemetry buffer 502, in order to provide a flight mode estimate. In still another example, solar estimator 514 may depend on a position estimate from position estimator 504 (e.g., indicating a position relative to the sun), a pressure estimate from pressure estimator 508, a flight mode estimate from flight mode estimator 512, and other data (e.g., time of day), in order determine an amount of solar power being captured by an aerial vehicle's solar power system. In yet other examples, ambient temperature estimator 522 may depend on outputs from solar estimator 514, ambient temperature estimator 518, infrared estimator 520 (i.e., configured to estimate an amount of upwelling infrared radiation being experienced by an aerial vehicle), weather model estimator 510, pressure estimator 508, and flight mode estimator 512; superpressure estimator 516 may depend on outputs from telemetry buffer 502; gas estimator 524 may depend on outputs from solar estimator 514, flight mode estimator 512, superpressure estimator 516, altitude estimator 506, temperature estimator 522 and mass estimator 526; physics estimator 528 may depend on outputs from superpressure estimator 516, temperature estimator 522 and mass estimator 526; ballast estimator 530 (i.e., configured to determine an amount of ballast available for dropping and/or an amount or increment of ballast to drop) may depend on outputs from flight mode estimator 512 and telemetry from telemetry buffer 502; mass estimator 526 (i.e., configured to estimate a current system mass of the vehicle) may depend on output from ballast estimator 530; and zero pressure estimator 532 may depend on outputs from physics estimator 528, gas estimator 524, and flight mode estimator 512.

In FIG. 5B, dependency tree 550 for power estimation shows a first tier of estimators, including telemetry buffer 502, position estimator 504, and pressure estimator 508, generating estimates on which downstream estimators depend in order to generate their respective estimates. The first tier of estimators may derive or compute their estimates from sensor data, telemetry buffer 502, and/or other data sources. As shown, weather model estimator 510 may depend on outputs from position estimator 504 and pressure estimator 508; flight mode estimator 512 may depend on outputs from position estimator 504, pressure estimator 508, and telemetry from telemetry buffer 502; ambient temperature estimator 518 may depend on output from weather model estimator 510; physics estimator 528 may depend on outputs from flight mode estimator 512, mass estimator 526, temperature estimator 522, ambient temperature estimator 518, and telemetry from telemetry buffer 502; solar estimator 514 may depend on outputs from flight mode estimator 512, pressure estimator 508, and position estimator 504; mass estimator 526 may depend on telemetry from telemetry buffer 502; temperature estimator 522 may depend on outputs from solar estimator 514, weather model estimator 510, pressure estimator 508, and infrared estimator 520; infrared estimator 520 may depend on output from solar estimator 514; gas estimator 524 may depend on output from mass estimator 526, pressure estimator 508, ambient temperature estimator 518, and solar estimator 514; ACS power estimator 554 may depend on output from physics estimator 528 and solar estimator 514; battery state estimator 552 (i.e., configured to estimate a battery charge level for the vehicle) may depend on output from solar estimator 514; critical battery estimator 556 (i.e., configured to estimate a future time and/or probability that the battery power will fall below a critical battery threshold, whether to change power modes (e.g., to conserve battery power or to restore more operational functions after a period of power conservation)) may depend on output from solar estimator 514, battery state estimator 552, and position estimator 504; load estimator 558 (i.e., configured to estimate an electrical load for operating in various modes (e.g., a low power mode, a current mode, a full operational mode) for a period of time (e.g., through a night, until a next sunrise, a given number of hours)) may depend on outputs from position estimator 504, temperature estimator 522, gas estimator 524, battery state estimator 552, and telemetry from telemetry buffer 502; solar power estimator 560 may depend on output from flight mode estimator 512, solar estimator 514, and telemetry from telemetry buffer 502.

In FIG. 5C, dependency tree 570 is a high level dependency tree of exemplary estimators, including lifetimes, power, and ballast estimators. Dependency tree 570 shows a first tier of estimators, including telemetry buffer 502, position estimator 504, and pressure estimator 508, generating estimates on which downstream estimators depend in order to generate their respective estimates. The first tier of estimators may derive or compute their estimates from sensor data, telemetry buffer 502, and/or other data sources.

All like-numbered elements in FIGS. 5A-5C operate and function in the same or similar manner. A person of ordinary skill in the art will recognize that dependency trees 500, 550 and 570 may include additional or fewer dependencies among the depicted estimators, as well as with other estimators. As shown, weather model estimator 510 may depend on output from position estimator 504 and pressure estimator 508; flight mode estimator 512 may depend on outputs from position estimator 504, pressure estimator 508, and telemetry from telemetry buffer 502; solar estimator 514 may depend on outputs from position estimator 504 and flight mode estimator 512; ballast estimator 530 may depend on outputs from flight mode estimator 512 and telemetry from telemetry buffer 502; ambient temperature estimator 518 may depend on outputs from weather model estimator 510 and solar estimator 514; temperature estimator 522 may depend on outputs from ambient temperature estimator 518; gas estimator 524 may depend on outputs from pressure estimator 508 and temperature estimator 522; battery state estimator 552 may depend on telemetry from telemetry buffer 502; ACS power estimator may depend on outputs from solar estimator 514, physics estimator 528, and telemetry from telemetry buffer 502; physics estimator 528 may depend on outputs from position estimator 504, pressure estimator 508, ambient temperature estimator 518, temperature estimator 522, and ballast estimator 530. A last layer of estimators configured to output a vehicle's state values and/or probabilities for use by other jobs in a fleet management system may include a zero pressure estimator 532 depending on outputs from physics estimator 528 and gas estimator 524; a ballast drop estimator 572 depending on outputs from physics estimator 528 and ballast estimator 530; a load estimator 558 depending on outputs from solar estimator 514, gas estimator 524 and ACS power estimator 554; a critical battery estimator 556 depending on outputs from battery state estimator 552, solar estimator 514 and telemetry from telemetry buffer 502; and a solar power estimator 560 depending on outputs from solar estimator 514, battery state estimator 552, flight mode estimator 512, and telemetry from telemetry buffer 502.

### Example Methods

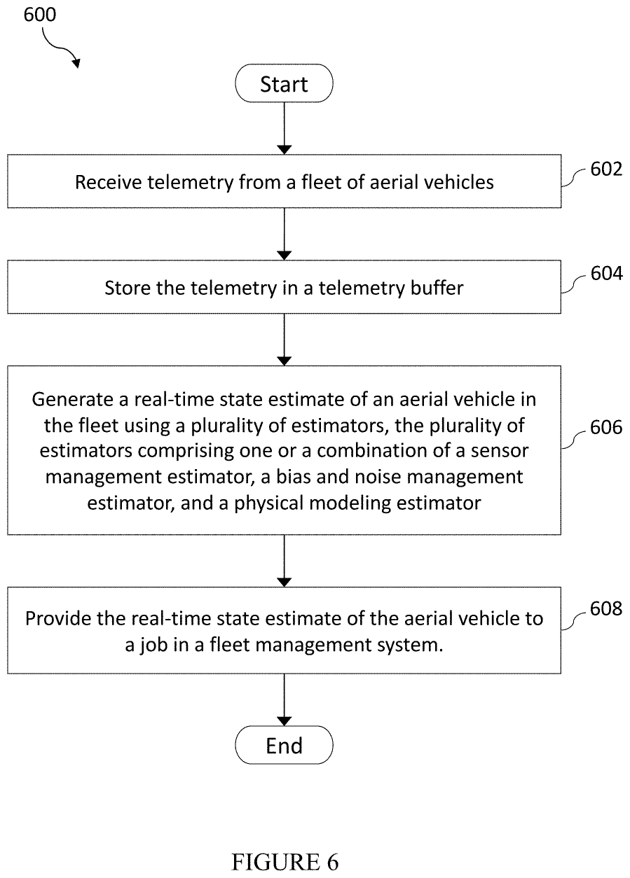

FIG. 6 is a flow diagram illustrating an exemplary method for real-time state estimation and sensor management, in accordance with one or more embodiments. Method 600 begins with receiving telemetry from a fleet of aerial vehicles at step 602. The received telemetry may be stored in a telemetry buffer in step 604. A real-time state estimate of an aerial vehicle in the fleet may be generated using a plurality of estimators at step 606, the plurality of estimators comprising one or a combination of a sensor management estimator, a bias and noise management estimator, and a physical modeling estimator. In some examples, as described herein, the telemetry buffer may be configured to store asynchronously received telemetry and provide a most recent version of the telemetry to the plurality of estimators. In some examples, step 606 may include generating a lifetime estimate by a zero pressure estimator, the lifetime estimate comprising an estimated number of days until a probability that the aerial vehicle will reach a zero pressure threshold exceeds a zero pressure probability threshold. In some examples, generating the lifetime estimate may include generating a temperature estimate by a temperature estimator configured to model the temperature estimate based on one or a combination of, a solar estimate, an ambient temperature estimate, an infrared estimate, and a pressure estimate, generating a gas amount estimate by a gas estimator, and generating a leak rate estimate by a physics estimator, wherein the lifetime estimate is based on the leak rate. In some examples, step 606 also may include generating a solar power estimate by a solar power estimator, the solar power estimate comprising an estimated distribution of power available for a given period of time. The given period of time may be until a next sunrise, until a next sunset, a given number of hours, or other time period. Generating the solar power estimate may include generating a battery state estimate by a battery state estimator, generating a solar capture estimate by a solar estimator configured to estimate an amount of solar power being captured by one or more solar panels onboard the aerial vehicle, and generating a position estimate by a position estimator, wherein the solar power estimate is based on the battery state estimate, the solar capture estimate, and a time of day based in part on the position estimate. For example, the position estimate may include a position relative to the sun from which a time until next sunrise or sunset may be derived. In some examples, step 606 also may include generating a ballast drop estimate by a ballast drop estimator. In still other examples, step 606 may include selecting a sensor signal from a plurality of sensor signals, wherein one or more of the plurality of sensor signals is filtered. In yet other examples, step 606 may include fusing a plurality of sensor signals.

Thus, in an example, the real-time state estimate of the aerial vehicle may include a lifetime estimate, a solar power estimate, and a ballast drop estimate. In other examples, the real-time state estimate also may include a load estimate, a critical battery estimate, a zero pressure estimate, and other vehicle state estimates. Said real-time state estimate of the aerial vehicle may be provided to a job in a fleet management system at step 608. In some examples, the job may include a plurality of simulations (e.g., flight simulations, power simulations, weather simulations, ballast drop simulations, and the like), for example, implemented by a flight simulator configured to predict future states (e.g., position, pressure, weather environment, battery state, and the like) of the aerial vehicle. In other examples, the job may include navigation control of the aerial vehicle implemented by a controller configured to generate a command for a next action for the aerial vehicle. In still other examples, the job may include vehicle dispatch implemented by a dispatcher configured to assign the aerial vehicle to a mission. In yet other examples, the job may include vehicle allocation implemented by a vehicle allocator configured to allocate the aerial vehicle to a dispatcher. In some examples, the job may be implemented in a datacenter as a standalone job that is queryable via remote procedure calls (RPCs) from other jobs (i.e., in need of information from the job).

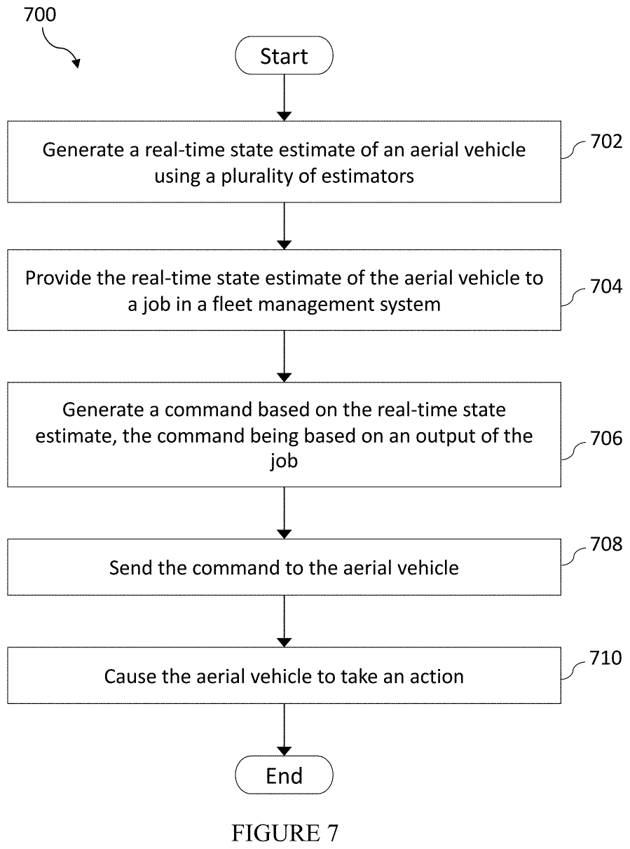

FIG. 7 is a flow diagram illustrating an exemplary method for using real-time state estimation and sensor management to control an aerial vehicle, in accordance with one or more embodiments. Method 700 may begin with generating a real-time state estimate of an aerial vehicle using a plurality of estimators at step 702. The real-time estimate of the aerial vehicle may be provided to a job in a fleet management system at step 704. A command may be generated based on the real-time state estimate at step 706, the command being based on an output of the job. The command may be navigation-related (e.g., configured to cause the aerial vehicle to change its altitude, direction, heading, destination, and the like), power-related (e.g., configured to cause the aerial vehicle to turn off power to a component, change its power mode, redirect power, change a power mode (e.g., critical battery or battery preservation mode), and the like), lifetime-related (e.g., configured to cause the aerial vehicle to drop ballast to stay within (aka avoid) superpressure or zero pressure thresholds, make an emergency maneuver (e.g., using the ACS, an emergency valve, or propulsion) to avoid a storm, a restricted zone, or other obstacle, turn on or off heaters, change a mode of operation), communications-related (e.g., configured to cause the aerial vehicle to turn on or off communications unit or components thereof, change communications mode (e.g., to tune communications standard or protocol, frequency of communications with ground infrastructure and/or other nodes in a network, stop or start sending messages of a given type (e.g., emergency communications, fully operational communications, telemetry, partial telemetry, data service, test communications)), among other commands. The command may be sent to the aerial vehicle at step 708, and may cause the aerial vehicle to take an action at step 710.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for state estimation for an aerial vehicle, the method comprising:
receiving telemetry from a fleet of aerial vehicles;
storing the telemetry in a telemetry buffer;
generating a real-time state estimate of an aerial vehicle in the fleet using a plurality of estimators, the plurality of estimators comprising one or a combination of a sensor management estimator, a bias and noise management estimator, and a physical modeling estimator; and
providing the real-time state estimate of the aerial vehicle to a job in a fleet management system.

2. The method of claim 1, further comprising causing the fleet management system to:
generate a command based on the real-time state estimate; and
send the command to the aerial vehicle.

3. The method of claim 2, wherein the command is configured to cause the aerial vehicle to change its altitude.

4. The method of claim 2, wherein the command is configured to cause the aerial vehicle to turn off power to a component.

5. The method of claim 2, wherein the command is configured to cause the aerial vehicle to change a mode of operation.

6. The method of claim 2, wherein the command is configured to cause the aerial vehicle to drop an increment of ballast.

7. The method of claim 1, wherein the job is implemented by a flight simulator configured to predict future states of the aerial vehicle.

8. The method of claim 1, wherein the job is implemented by a controller configured to generate a command for a next action for the aerial vehicle.

9. The method of claim 1, wherein the job is implemented by a dispatcher configured to assign the aerial vehicle to a mission.

10. The method of claim 1, wherein the job is implemented by a vehicle allocator configured to allocate the aerial vehicle to a dispatcher.

11. The method of claim 1, wherein the job is implemented in a datacenter as a standalone job, wherein the job is configured to be queried by a remote procedure call from another job.

12. The method of claim 1, wherein generating the real-time state estimate comprises generating a lifetime estimate by a zero pressure estimator, the lifetime estimate comprising an estimated number of days until a probability that the aerial vehicle will reach a zero pressure threshold exceeds a zero pressure probability threshold.

13. The method of claim 12, wherein generating the real-time state estimate further comprises:
generating a temperature estimate by a temperature estimator configured to model the temperature estimate based on one or a combination of, a solar estimate, an ambient temperature estimate, an infrared estimate, and a pressure estimate,
generating a gas amount estimate by a gas estimator, and
generating a leak rate estimate by a physics estimator,
wherein the lifetime estimate is based on the leak rate.

14. The method of claim 1, wherein generating the real-time state estimate comprises generating a solar power estimate by a solar power estimator, the solar power estimate comprising an estimated distribution of power available for a given period of time.

15. The method of claim 14, wherein the given period of time is until a next sunrise.

16. The method of claim 14, wherein generating the real-time state estimate further comprises:
generating a battery state estimate by a battery state estimator,
generating a solar capture estimate by a solar estimator configured to estimate an amount of solar power being captured by one or more solar panels onboard the aerial vehicle, and
generating a position estimate by a position estimator,
wherein the solar power estimate is based on the battery state estimate, the solar capture estimate, and a time of day based in part on the position estimate.

17. The method of claim 1, wherein generating the real-time state estimate comprises generating a ballast drop estimate by a ballast drop estimator.

18. The method of claim 1, wherein the telemetry buffer is configured to store asynchronously received telemetry and provide a most recent version of the telemetry to the plurality of estimators.

19. The method of claim 1, wherein generating the real-time state estimate comprises selecting a sensor signal from a plurality of sensor signals, wherein one or more of the plurality of sensor signals is filtered.

20. The method of claim 1, wherein generating the real-time state estimate comprises fusing a plurality of sensor signals.

21. A distributed computing system comprising:
a distributed database configured to store flight simulation data and geographical restrictions data; and
one or more processors configured to:
receive telemetry from a fleet of aerial vehicles;
store the telemetry in a telemetry buffer;
generate a real-time state estimate of an aerial vehicle in the fleet using a plurality of estimators, the plurality of estimators comprising one or a combination of a sensor management estimator, a bias and noise management estimator, and a physical modeling estimator; and
provide the real-time state estimate of the aerial vehicle to a job in a fleet management system.
